(19) United States
(12) Patent Application Publication
(10) Pub. No.: US 2024/0114844 A1
(43) Pub. Date: Apr. 11, 2024

(54) METHOD AND SYSTEM FOR PROCESSING BALED STRAW

(71) Applicant: Roy BREWIN, Taber (CA)

(72) Inventor: Roy BREWIN, Taber (CA)

(21) Appl. No.: 17/768,685

(22) PCT Filed: Jul. 9, 2020
(86) PCT No.: PCT/CA2020/050947

§ 371 Date: Apr. 13, 2022

Related U.S. Application Data
(60) Provisional application No. 62/871,824, filed on Jul. 9, 2019.

(51) Int. Cl. A01F 29/00; A01D 87/02; A01D 87/10

(52) U.S. Cl. CPC A01F 29/005; A01D 87/02; A01D 87/10; A01D 85/005

(57) ABSTRACT

The present invention provides a system for processing a bale of straw to provide a hurd fraction, a fiber fraction and a dust fraction. The system comprises a bale cutting assembly configured to cut the bale into a plurality of vertically stacked cut bale segments by making one or more horizontal cuts through the bale and to eject a lowermost one of the plurality of the cut bale segments onto a first conveyor assembly, which separates the bale segment into straw wafers and convey them into a flail assembly comprising a plurality of flails/beaters to convert straw wafers into loose straw. The loose straw are discharged into a grinding assembly via a second conveyor assembly, to provide a mixture of hurd, fiber and dust. A separation assembly receives and separate the mixture of hurd, fiber and dust into the hurd fraction, the fiber fraction and the dust fraction.

### CROSS-REFERENCE TO RELATED APPLICATIONS

This application claims the benefit of priority to U.S. Patent Application Ser. No. 62/871,824 entitled “METHOD AND SYSTEM FOR PROCESSING BALED STRAW” filed Jul. 9, 2019, which is hereby incorporated by reference in its entirety.

### FIELD OF THE INVENTION

The present invention relates to a system and method for processing baled straws to separate fibers, hurd and crop dust fractions.

### BACKGROUND

Industrial hemp production for human and animal use has grown dramatically in recent years due in large part to the use of hemp products in food stuffs. This growth has been propelled by food use alone. However, hemp fibre processing capacity to date has been very limited. The main issue restricting growth, cited by the Federal/Provincial/Territories Working Group, is the lack of an integrated supply chain for natural fibre materials. The inability to process straws of crops such as hemp and flax is a factor limiting the ability to increase production acreage of these crops.

The current focus of conventional straw decortication technology is to separate fibre from hurd, using retted long-fibre straws as input.

U.S. Pat. No. 10,052,636 discloses a method and system for processing whole hemp stalks into particulate hemp such that the particulate hemp comprises both bast fiber and shire of the original whole hemp stalks, using conventional shredding and grinding technology to produce particulate hemp products such as hemp fines, hemp pellets, and hemp crumbs.

There is still a need for a system and method for processing bales of dried, combined, short, unretted straws to add value to shorter fibre straws, which constitute by-product streams of conventional long fibre decortication processes for crops like hemp and flax.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system for processing baled straw.

In accordance with an aspect of the present invention there is provided a system for processing a bale of straw to provide a hurd fraction, a fiber fraction and a dust fraction, the system comprising: a) a bale cutting assembly which comprises a receiving station for receiving and holding the bale of straw, a cutting station comprising a cutter mechanism configured to receive the bale from the receiving station and cut the bale into a plurality of vertically stacked cut bale segments by making one or more horizontal cuts through the bale, an ejector configured to eject a lowermost one of the plurality of the cut bale segments from the cutting station; b) a first conveyor assembly configured to receive a bale segment ejected from the cutting station, convey the ejected bale segment away from the bale cutting assembly, and separate the bale segment into straw wafers, wherein the first conveyor assembly comprises one or more conveyor belts; c) a flail assembly configured to receive the straw wafers from the first conveyor assembly and convert the straw wafers into loose straw, the flail assembly comprises a flail member comprising a horizontally oriented rotating shaft having a plurality of flails/beaters fixed thereto and extending radially outward therefrom, and a straw conveying surface having a receiving end portion and a discharge end portion; d) a second conveyor assembly in communication with the flail assembly and configured to convey the loose straw away from the flail assembly; e) a grinding assembly for receiving the loose straw from the second conveyor assembly, the grinding assembly comprises a grinding/cutter member to grind, decorticate and separate fibers from the hurd of the loose straw to provide a mixture of hurd, fiber and dust; and f) a separation assembly for separating the mixture of hurd, fiber and dust into the hurd fraction, the fiber fraction and the dust fraction.

In accordance with another aspect of the present invention, there is provided a method of processing baled straw using the system as described herein. The method comprises cutting the bale into a plurality of vertically stacked cut bale segments by making one or more horizontal cuts through the bale in a cutting station; ejecting a lowermost one of the plurality of the cut bale segments from the cutting station on to a first conveyor assembly and separating the bale segment into straw wafers; conveying the straw wafers from the first conveyor assembly into a flail assembly and converting the straw wafers into loose straw in the flail assembly and discharging the loose straw on to a second conveyor assembly; conveying the loose straw from the second conveyor assembly into a grinding assembly, and grinding the loose straw to provide a mixture of hurd, fiber and dust; and separating the mixture of hurd, fiber and dust into the hurd fraction, the fiber fraction and the dust fraction in a separation assembly.

### BRIEF DESCRIPTION OF THE DRAWINGS

The invention will now be described by way of an exemplary embodiment with reference to the accompanying simplified, diagrammatic drawings. In the drawings:

FIG. 1 depicts a top perspective view of the bale cutting assembly from the receiving side thereof, in accordance with an embodiment of the present invention.

FIG. 2 depicts a top perspective view of the bale cutting assembly from the receiving side thereof, in accordance with an embodiment of the present invention.

FIG. 3 depicts a top perspective view of the bale cutting assembly from the conveying side thereof, in accordance with an embodiment of the present invention.

FIG. 4 depicts a partial end perspective view of the processing system in accordance with an embodiment of the present invention.

FIG. 5 depicts a partial view of the processing system in accordance with an embodiment of the present invention, showing elements of the flail assembly.

FIG. 6 depicts a partial view of the processing system in accordance with an embodiment of the present invention, showing portions of the first and second conveyor assemblies.

FIG. 7 depicts a partial perspective view of the upwardly inclined conveyor belt of the second conveyor assembly, a magnetic separation system for catching metals, and a portion of the inlet chute for the grinding assembly, of the processing system in accordance with an embodiment of the present invention.

FIG. 8 depicts a top view of a processing system in accordance with an embodiment of the present invention, showing part of the magnetic separation system, inlet chute and grinder hammers of the grinding assembly.

FIG. 9 depicts a portion of the interior of the hammer mill portion of the processing system in accordance with an embodiment of the present invention.

FIG. 10 depicts a perspective view of a removal grate placed at the bottom of the hammer mill of the processing system in accordance with an embodiment of the present invention.

FIG. 11 depicts a top perspective view of a blower unit of the separation assembly of the processing system in accordance with an embodiment of the present invention.

FIG. 12 depicts a rear view of a cyclone unit of the separation assembly of the processing system in accordance with an embodiment of the present invention.

FIG. 13 depicts a partial view of the processing system showing a separation assembly connected with an outlet of the grinding assembly.

### DETAILED DESCRIPTION

### Definitions

Unless defined otherwise, all technical and scientific terms used herein have the same meaning as commonly understood by one of ordinary skill in the art to which this invention belongs.

As used herein, the term “about” refers to approximately a +/−10% variation from a given value. It is to be understood that such a variation is always included in any given value provided herein, whether or not it is specifically referred to.

The present invention provides a novel system and method for processing bales of short straw of crops such as hemp and flax, which comprises a unique combination of subsystems involving mechanical, pneumatic, hydraulic and gravity-based material handling techniques for conducting commercial scale separation to obtain desired products. In a preferred embodiment, the present invention can be used to process whole 4′×4′×8′ short straw bales.

The system of the present application can process post-harvest straw which has been swathed, dried, combined and baled. The system has the capability of breaking short-length straws into a composite short length hurd/fibre combination, which can be subjected to further processing or utilized in “as-is” form in a number of bedding, weed control or natural absorbent applications.

In accordance with one aspect, the present invention provides a system for processing a bale of straws (such as hemp straw and flax straw) to provide a hurd fraction, a fiber fraction and a dust fraction. The system comprises a bale cutting assembly, a first conveyor assembly, a flail assembly, a second conveyor assembly, a grinding assembly and a separation assembly.

The bale cutting assembly comprises a receiving station for receiving and holding a bale of straw, a cutting station comprising a cutter mechanism configured to cut the bale into a plurality of vertically stacked bale segments by making one or more horizontal cuts through the bale, and an ejector configured to eject a lowermost one of the plurality of bale segments from the cutting station.

In some embodiments, the cutter mechanism comprises two horizontal cutting rods/blades configured to cut a bale into three vertically stacked segments.

In some embodiments, the receiving station is configured to move the bale of straw into the cutting station.

After the bale has been cut into vertically stacked segments, each segment undergoes further processing, one bale at a time, to provide the desired hurd, fiber and dust fractions.

Once the bale has been cut, the first conveyor assembly is configured to receive a bale segment ejected from the cutting station, convey the ejected bale segment away from the bale cutting assembly, and separate the bale segment into straw wafers. The first conveyor assembly comprises one or more conveyor belts configured to transport the bale segment to the next stage for further processing in the flail assembly. The length, speed and/or incline of the conveyor belts is selected to facilitate the separation of wafers to better enable downstream processing.

The flail assembly is configured to receive the straw wafers from the first conveyor assembly and convert the straw wafers into loose straw. The flail assembly comprises a straw conveying surface having a receiving end portion and a discharge end portion, and a flail member for breaking the wafers into loose straw.

After being processed in the flail assembly, the lose straw is conveyed on a second conveyor assembly having a receiver end portion positioned in communication with the discharge end portion of the straw conveying surface of the flail assembly, and is configured to convey the loose straw away from the flail assembly towards a grinding assembly. The second conveyor assembly comprises one or more conveyor belts.

The grinding assembly is positioned in communication with a discharge end of the second conveyor assembly to receive the loose straw conveyed away from the flail assembly. The grinding assembly comprises a grinding/cutter member to grind, decorticate and separate fibers from the hurd of the loose straw to provide a mixture of hurd, fiber and dust.

The mixture is then fed into a separation assembly, which is configured to receive the mixture of hurd, fiber and dust from the grinding assembly, and separate it into the hurd fraction, the fiber fraction and the dust fraction.

In preferred embodiments, the bale cutting assembly is comprised of a housing having a receiving side and a conveying side, wherein a receiving station and a cutting station are located within the housing. The housing has a door at the receiving side to receive a bale of straw into the receiving station, and the housing is further configured to push the bale of straw into the cutting station.

In some embodiments, an ejector is provided comprising one or more linear actuators (configured to push the lowermost one of the cut bale segments horizontally from the floor of the cutting station onto the first conveyor assembly.

In some embodiments, the one or more linear actuators comprise a ram-piston combination. In some embodiments, the ram-piston combination comprises two ram members attached to a piston member.

In some embodiments, at least one of the one or more conveyors belts of the first conveyor assembly comprises an upwardly inclined conveyor belt.

In some embodiments, the first conveyor assembly comprises a receiving conveyor belt to receive the bale segment ejected from the cutting station, and an upwardly inclined conveyor belt in communication with the receiving conveyor belt for conveying the ejected bale segment away from the bale cutting assembly and towards the flail assembly.

The upwardly inclined conveyor belt of the first conveyor assembly can provide for a gravity assisted separation of the bale segment into the straw wafers.

The length, speed and/or incline of the conveyor belts is selected to facilitate the separation of wafers to better enable downstream processing.

The straw conveying surface of the flail assembly has a receiving end portion to receive the straw wafers from the first conveyor assembly and a discharge end portion in communication with the second conveyor assembly. The straw conveying surface is downwardly inclined from the receiving end portion towards the discharge end portion.

In some embodiments, the straw conveying surface is downwardly inclined and inwardly curved from the receiving end portion towards the discharge end portion.

The flail member of the flail assembly comprises a horizontally oriented rotating shaft having a plurality of flails/beaters provided to beat the straw wafers, breaking the wafers apart into loose straw.

In some embodiments, a gap is provided between the discharge end portion of the straw conveying surface of the flail assembly and the receiver end of the second conveyor assembly to allow heavy non-straw materials (wood, rocks, etc.) to fall through the gap, thereby minimizing the amount of the heavy non-straw materials being passed on to the next processing stage.

In a preferred embodiment, adjacent flails/beaters on the rotating shaft of the flail assembly are provided in an offset arrangement.

In some embodiments, the straw conveying surface of the flail assembly further comprises a plurality of v-shaped protrusions to impede the straw wafers from sliding through the flail assembly before undergoing conversion to loose straw, while allowing rock and debris to fall out. In some embodiments, the v-shaped protrusions are provided towards or at the discharge end portion of the straw conveying surface.

In some embodiments, the second conveyor assembly comprises an upwardly inclined conveyor belt to convey the loose straw toward the grinding assembly.

The grinding assembly has an inlet in communication with the discharge end of the second conveyor assembly to receive the loose straw. In some embodiments, the grinding assembly has an inlet chute in communication with the discharge end of the second conveyor assembly to receive the loose straw.

In preferred embodiments, the grinding assembly comprises a hammer mill comprising a feed chute/hopper, a grinding chamber equipped with a grinder member comprising a plurality of grinder hammers attached to shaft configured to rotate at variable speed, wherein the loose straw material is crushed by a combination of hammer blows, collision with the walls of the grinding chamber, and particle-on-particle impacts.

In some embodiments, the grinding assembly further comprises a replaceable grinder screen/grate having openings of a desired size, positioned at the bottom of the grinding chamber, such that the grinder hammers drive the straw through grate once the straw has been processed to the desired size.

A screen/grate with opening of desired size(s) can be selected to set the intensity of grinding, for example smaller openings/holes increase grinding intensity. In some embodiments the grinder screen openings size is about 0.5 inch to about 2 inch.

In some embodiments, the system further comprises a magnetic separation system positioned between the discharge end of the second conveyor system and the inlet of the grinding assembly, to capture metallic material from the loose straw prior to being discharged into the grinding assembly.

In some embodiments, the magnetic separation system comprises a magnetic roller configured to rotate away from the inlet end of the grinding assembly. In some embodiments, the magentic roller is comprised of a plurality of magnetic wheels together forming the roller.

The grinding assembly grinds, decorticates and separates fibers from the hurd of the loose straw to form a mixture of hurd, fiber and dust that is passed into a separation assembly to separate the mixture into the hurd fraction, fiber fraction and the dust fraction.

In some embodiments, the separation assembly comprises a blower unit and a cyclone unit, wherein the blower unit is configured to receive the mixture of hurd, fiber and dust from the grinding assembly and blow it into the cyclone unit to separate the mixture into the hurd fraction, fiber fraction and dust fraction.

In some embodiments, the system is for processing bales of hemp straw. In some embodiments, the system is for processing bales of flax straw.

In accordance with another aspect, the present invention provides a method of processing a bale of straw to provide a hurd fraction, a fiber fraction and a dust fraction, comprising: cutting the bale into a plurality of bale segments and separating the cut bale segment into straw wafers; flailing the straw wafers into loose straw; grinding the loose straw to provide a mixture of hurd, fiber and dust; and separating the mixture of hurd, fiber and dust into the hurd fraction, the fiber fraction and the dust fraction.

In some embodiments, the method involves use of the system described herein, and comprises cutting the bale into a plurality of vertically stacked cut bale segments by making one or more horizontal cuts through the bale in a cutting station; ejecting a lowermost one of the plurality of the cut bale segments from the cutting station on to a first conveyor assembly and separating the bale segment into straw wafers; conveying the straw wafers from the first conveyor assembly into a flail assembly and converting the straw wafers into loose straw in the flail assembly and discharging the loose straw on to a second conveyor assembly; conveying the loose straw from the second conveyor assembly into a grinding assembly, and grinding the loose straw to provide a mixture of hurd, fiber and dust; and separating the mixture of hurd, fiber and dust into the hurd fraction, the fiber fraction and the dust fraction in a separation assembly.

The present invention therefore provides an improved system and method of processing baled short straw of crops such as hemp and flax, into a combination of short length hurd, fibre and dust, which can be subjected to further processing or utilized in “as-is” form in a number of applications.

To gain a better understanding of the invention described herein, the following examples are set forth. It will be understood that these examples are intended to describe illustrative embodiments of the invention and are not intended to limit the scope of the invention in any way.

### Examples

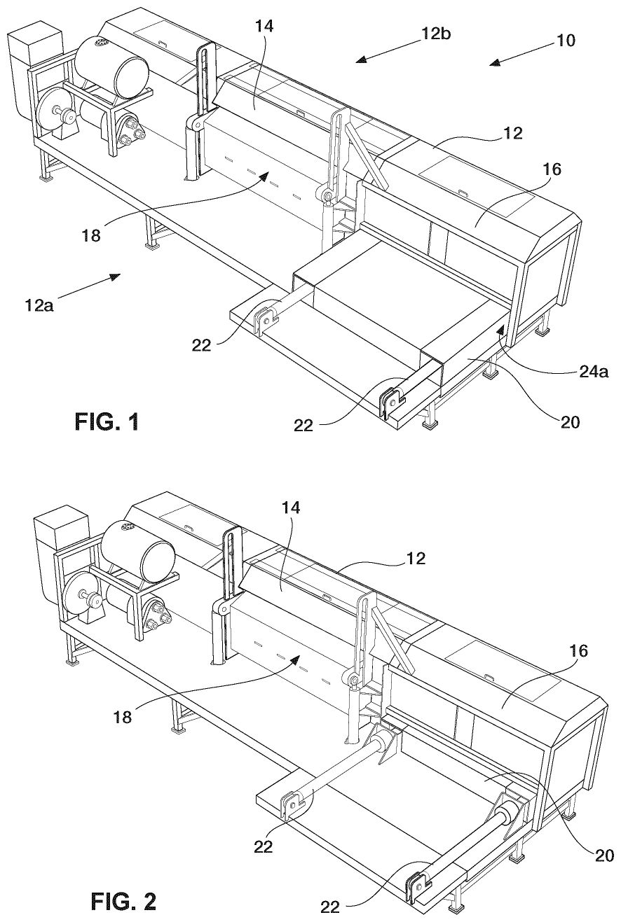

FIGS. 1 to 3 depict top perspective views of an exemplary bale cutting assembly 10 of the system of the present invention. In this embodiment, the bale cutting assembly is comprised of a housing 12 having receiving side 12a and conveying side 12b. The housing is configured to define a receiving station 14 and a cutting station 16 in communication with the receiving station. The housing has a door 18 to receive a bale of straw into the receiving station. The housing is further configured to push the bale of straw toward the cutting station. The cutting station is provided with two horizontally oriented cutting rods/blades (not shown) configured to cut the bale into three vertically stacked segments.

An ejector system comprising a ram portion 20, and two piston members 22 is provided on the receiving side of the housing at the cutting station. The side walls of the housing at the cutting station are provided with gaps/openings 24a and 24b, through which the ram portion of the ejector passes to deliver the lowermost bale portion onto the first conveyor assembly.

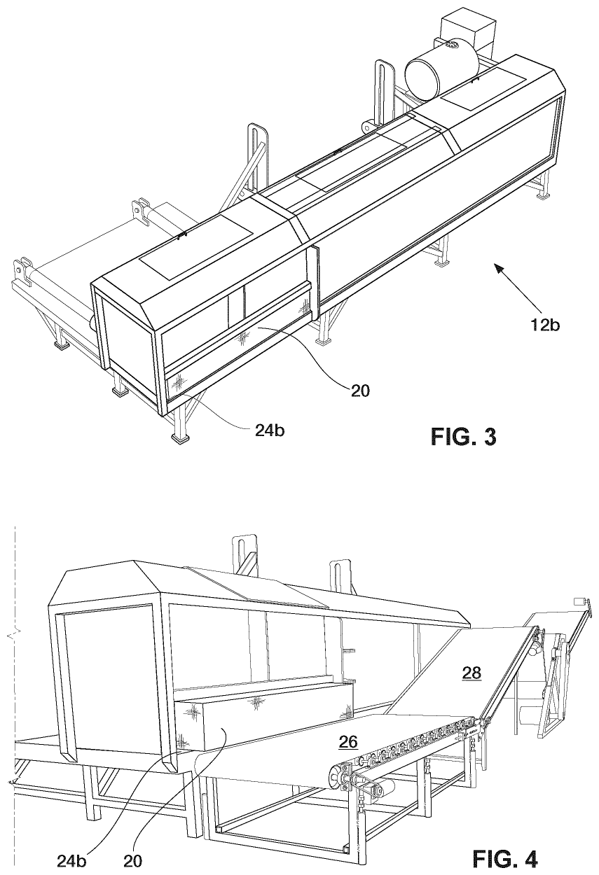

The ejector system is configured to move between a withdrawn position and a deployed positon. In the withdrawn position, the ram portion of the ejector is configured to be outside the housing as shown in FIG. 1, and in the deployed position, the ram portion of the ejector enters the housing via gap 24a to push and eject the lowermost one of the cut bale segments from the cutting station via gap 24b at the conveying side of the housing, as shown in FIGS. 2 and 3.

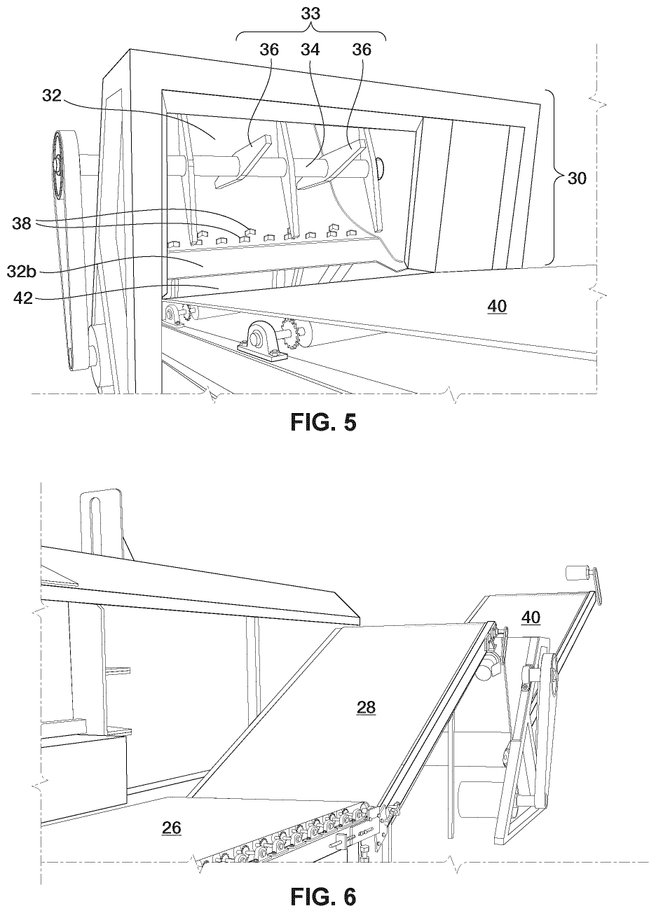

FIG. 4 depicts the first conveyor assembly in communication with the blade cutting station. In this embodiment, the first conveyor assembly comprises a substantially horizontally oriented receiving conveyor belt 26 in communication with gap 24b of the cutting station to receive the bale segment ejected by the ram portion 20 of the ejector, and an upwardly inclined conveyor belt 28 for conveying the ejected bale segment away from the bale cutting assembly and towards the flail assembly 30 (FIG. 5). The length, speed and/or incline of the conveyor belts is selected to facilitate the separation of wafers to better enable downstream processing.

FIG. 5 depicts a partial view of the flail assembly 30 and a portion of an upwardly inclined conveyor belt 40 of the second conveyor assembly. The flail assembly comprises a flail member 33 comprising a horizontally oriented rotating shaft 34 having a plurality of flails/beaters 36 fixed thereto and extending radially outward from the shaft. The flail assembly further comprises a downwardly inclined and inwardly curved straw conveying surface 32 having a receiving end portion (not visible in FIG. 5) and a discharge end portion 32b configured to be in communication with the receiver end portion of the conveyor belt 40 of the second conveyor assembly.

In this embodiment, a gap 42 is provided between the discharge end portion 32b of the straw conveying surface 32 and the received end portion 40a of the upwardly inclined conveyor belt 40 of the second conveying assembly, to allow heavy materials to fall through the gap. The straw conveying surface 32 is also provided with a plurality of v-shaped protrusions 38 for impeding the wafers from falling out of the flail assembly and the straw from sliding through the flail assembly before undergoing conversion to loose straw, while allowing rock and debris to fall out.

FIG. 6 depicts the conveyor belts 26 and 28 of the first assembly and conveyor belt 40 of the second conveyor assembly. The discharge end of the conveyor belt 28 and the receiver end of the conveyor belt 40 are in communication with the flail system (not visible in this view).

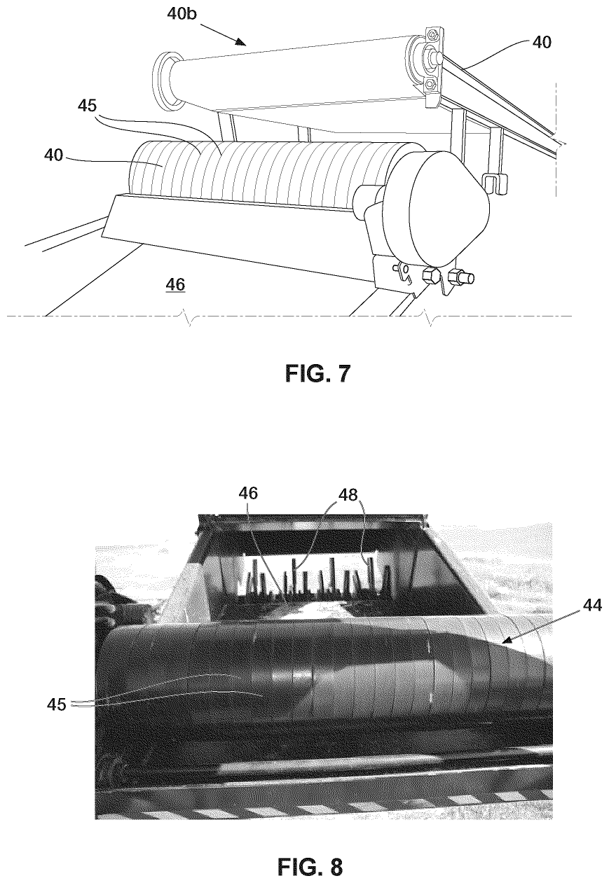

FIG. 7 depicts a partial perspective of the upwardly inclined conveyor belt 40 of the second conveyor assembly showing a magnetic roller 44 for catching metals, positioned between the discharge end 40b of the conveyor belt 40 and inlet chute 46 of the grinding assembly. The magnetic roller is comprised of a plurality magnetic wheels 45 arranged on a rotatable shaft. The shaft is configured to rotate away from the inlet end of the grinding assembly.

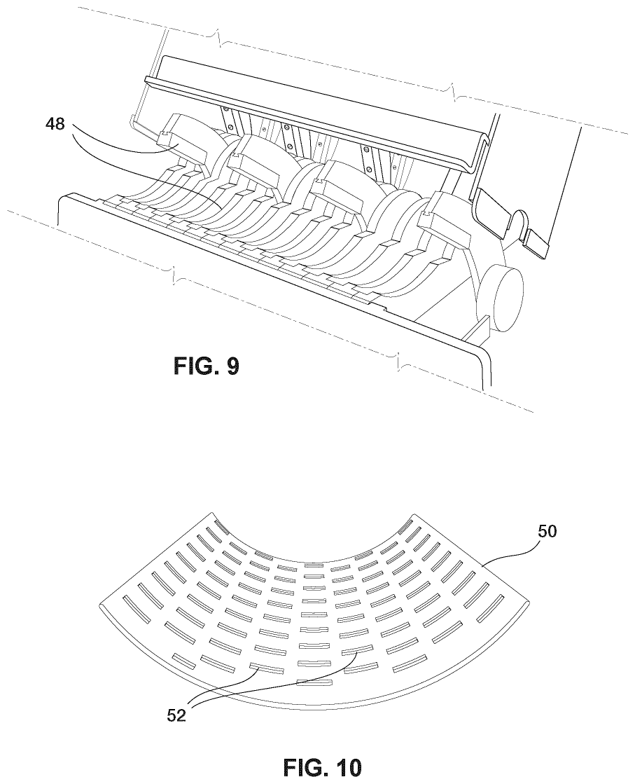

In this example, the grinding assembly comprises a hammer mill comprising a grinding chamber equipped with a grinder member comprising a plurality of grinder hammers attached to shaft configured to rotate at variable speed. FIG. 8 depicts a top view of a part of the processing system showing the magnetic roller 44, inlet chute 46 for the hammer mill, and grinder hammers 48 of the hammer mill. FIG. 9 depicts an interior view of a portion of the hammer mill showing the grinder hammers 48.

FIG. 10 depicts a perspective view of a grate/screen 50 having openings/holes 52 of desired size(s), which can be removably placed at the bottom of the grinding chamber.

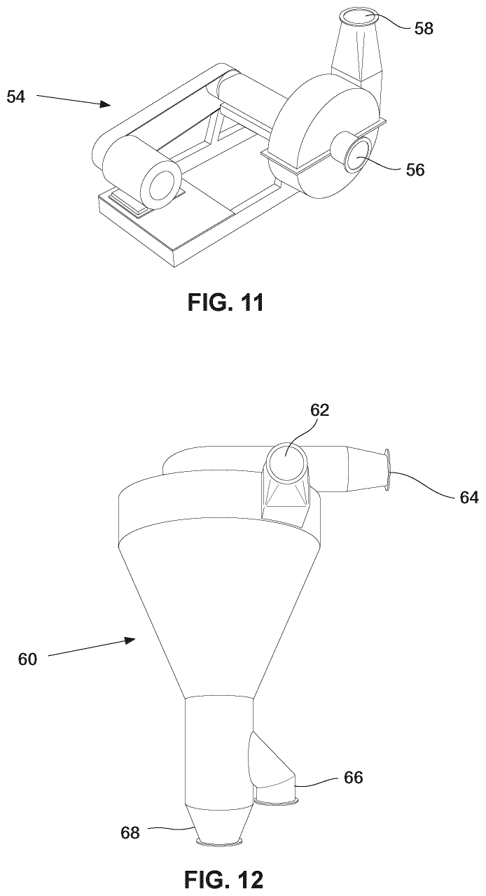

FIG. 11 depicts an example of a blower unit 54 having an inlet portion 56 to receive the ground straw from the outlet of the grinding assembly, and an outlet portion 58 to blow it into the cyclone unit to separate the ground straw into the hurd fraction, fiber fraction and dust fraction.

FIG. 12 depicts an example of cyclone unit 60 of the processing system. The cyclone unit has an inlet portion 62 configured to be connected to the outlet portion 58 of the blower. The cyclone further has outlet portions 64, 66 and 68 for discharging dust fraction, fiber fraction and hurd fraction, respectively.

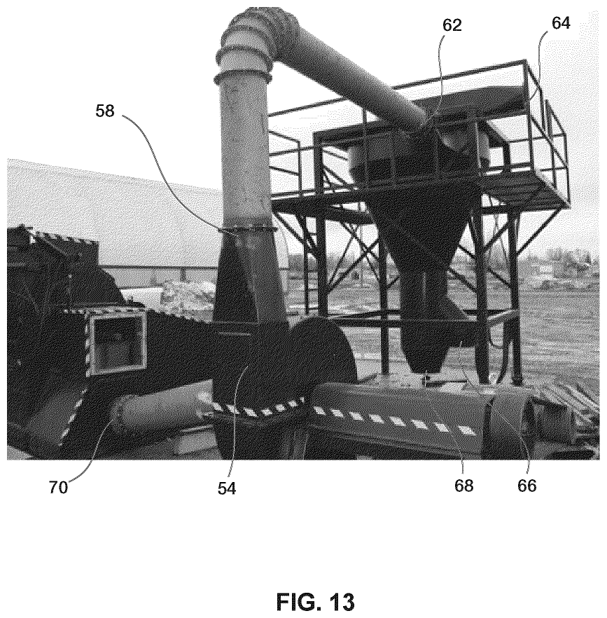

FIG. 13 depicts a partial view of the processing system showing connection between the inlet portion (not visible) of the blower unit 54 and the outlet portion 70 of the grinding assembly, and connection between the outlet portion 58 of the blower unit 54 and the inlet portion 62 of the cyclone unit 60.

Although the present invention has been described with reference to specific features and embodiments thereof, it is evident that various modifications and combinations can be made thereto without departing from the invention. The provided specification is, accordingly, to be regarded simply as an illustration of the invention as defined by the appended claims, and are contemplated to cover any and all modifications, variations, combinations or equivalents that fall within the scope of the present invention.

1. A system for processing a bale of straw to provide a hurd fraction, a fiber fraction and a dust fraction, the system comprising:
a) a bale cutting assembly comprising:
a receiving station for receiving and holding the bale of straw,
a cutting station comprising a cutter mechanism configured to receive the bale from the receiving station and cut the bale into a plurality of vertically stacked cut bale segments by making one or more horizontal cuts through the bale,
an ejector configured to eject a lowermost one of the plurality of the cut bale segments from the cutting station;
b) a first conveyor assembly configured to receive a bale segment ejected from the cutting station, convey the ejected bale segment away from the bale cutting assembly, and separate the bale segment into straw wafers, wherein the first conveyor assembly comprises one or more conveyor belts;
c) a flail assembly configured to receive the straw wafers from the first conveyor assembly and convert the straw wafers into loose straw, said flail assembly comprising:
a flail member comprising a horizontally oriented rotating shaft having a plurality of flails/beaters fixed thereto and extending radially outward therefrom, and a straw conveying surface having a receiving end portion and a discharge end portion;
d) a second conveyor assembly in communication with the flail assembly and configured to convey the loose straw away from the flail assembly;
e) a grinding assembly for receiving the loose straw from the second conveyor assembly, said grinding assembly comprising grinding/cutter member to grind, decorticate and separate fibers from the hurd of the loose straw to provide a mixture of hurd, fiber and dust; and
f) a separation assembly for separating the mixture of hurd, fiber and dust into the hurd fraction, the fiber fraction and the dust fraction.

2. The system of claim 1, wherein the ejector comprises one or more linear actuators configured to push said lowermost one of the bale segments horizontally from the cutting station onto the first conveyor assembly.

3. The system of claim 2, wherein the ejector comprises one or more piston members attached to a ram member.

4. The system of claim 1, wherein at least one of the one or more conveyors belts of the first conveyor assembly comprises a receiving conveyor belt to receive the bale segment ejected from the cutting station and an upwardly inclined conveyor belt for conveying the ejected bale segment away from the bale cutting assembly and towards the flail assembly.

5. The system of claim 1, wherein adjacent flails of the rotating shaft of the flail assembly are provided in an offset arrangement.

6. The system of claim 1, wherein the system is provided with a gap between the discharge end portion of the straw conveying surface of the flail assembly and a receiver end of the second conveyor assembly.

7. The system of claim 1, wherein the straw conveying surface of the flail assembly further comprises a plurality of v-shaped protrusions.

8. The system of claim 1, wherein the second conveyor assembly comprises an upwardly inclined conveyor belt.

9. The system of claim 1, wherein the system further comprises a magnetic separation system positioned between a discharge end of the second conveyor system and an inlet of the grinding assembly.

10. The system of claim 9, wherein the magnetic separation system comprises a magnetic roller configured to rotate away from the inlet end of the grinding assembly.

11. The system of claim 10, wherein the magnetic roller comprises a plurality of magnetic wheels arranged on a rotatable shaft.

12. The system of claim 1, wherein the grinding assembly comprises a hammer mill, comprising a grinding chamber equipped with a grinder member comprising a plurality of grinder hammers attached to shaft configured to rotate at variable speed.

13. The system of claim 12, wherein grinding assembly further comprises a replaceable grinder screen/grate having openings of a desired size, positioned at the bottom of the grinding chamber.

14. The system of claim 13, where said screen has openings of a size about 6.6 to about 2 inch.

15. The system of claim 1, wherein the separation assembly comprises a blower unit and a cyclone unit, wherein the blower unit is configured to receive the mixture of hurd, fiber and dust from the grinding assembly and blow it into the cyclone unit to separate the mixture into the hurd fraction, fiber fraction and dust fraction.

16. The system of claim 1, wherein the system is for processing bales of hemp straw and/or flax straw.

17. A method of processing a bale of straw to provide a hurd fraction, a fiber fraction and a dust fraction, using a system as defined in claim 1, the method comprising:
a) cutting the bale into a plurality of vertically stacked cut bale segments by making one or more horizontal cuts through the bale in a cutting station;
b) ejecting a lowermost one of the plurality of the cut bale segments from the cutting station on to a first conveyor assembly and separating the bale segment into straw wafers;
c) conveying the straw wafers from the first conveyor assembly into a flail assembly and converting the straw wafers into loose straw in the flail assembly and discharging the loose straw on to a second conveyor assembly;
d) conveying the loose straw from the second conveyor assembly into a grinding assembly, and grinding the loose straw to provide a mixture of hurd, fiber and dust; and
e) separating the mixture of hurd, fiber and dust into the hurd fraction, the fiber fraction and the dust fraction in a separation assembly.

18. The system of claim 17, wherein the ejector comprises one or more linear actuators configured to push said lowermost one of the bale segments horizontally from the cutting station onto the first conveyor assembly.

19. The system of claim 17, wherein at least one of the one or more conveyors belts of the first conveyor assembly comprises a receiving conveyor belt to receive the bale segment ejected from the cutting station and an upwardly inclined conveyor belt for conveying the ejected bale segment away from the bale cutting assembly and towards the flail assembly, and/or the second conveyor assembly comprises an upwardly inclined conveyor belt.

20. The system of claim 17, wherein adjacent flails of the rotating shaft of the flail assembly are provided in an offset arrangement, and/or the straw conveying surface of the flail assembly further comprises a plurality of v-shaped protrusions.

21. The system of claim 17, wherein the system further comprises a magnetic separation system positioned between a discharge end of the second conveyor system and an inlet of the grinding assembly, optionally the magnetic separation system comprises a magnetic roller configured to rotate away from the inlet end of the grinding assembly.

22. The system of claim 17, wherein the grinding assembly comprises a hammer mill, comprising a grinding chamber equipped with a grinder member comprising a plurality of grinder hammers attached to shaft configured to rotate at variable speed.

23. The system of claim 22, wherein grinding assembly further comprises a replaceable grinder screen/grate having openings of a desired size, positioned at the bottom of the grinding chamber.

24. The system of claim 17, wherein the separation assembly comprises a blower unit and a cyclone unit, wherein the blower unit is configured to receive the mixture of hurd, fiber and dust from the grinding assembly and blow it into the cyclone unit to separate the mixture into the hurd fraction, fiber fraction and dust fraction.
